(19) United States
(12) Patent Application Publication
(10) Pub. No.: US 2009/0248923 A1
(43) Pub. Date: Oct. 1, 2009

(54) NETWORK DEVICE AND ADAPTOR CARD TYPE DETECTION METHOD THEREOF

(75) Inventors: WEN-YUAN WANG, Tu-Cheng (TW); CHIEN-PAN LAI, Tu-Cheng (TW); HSIN-LUNG TU, Tu-Cheng (TW)

Correspondence Address: PCE INDUSTRY, INC.;ATT. Steven Reiss, 288 SOUTH MAYO AVENUE, CITY OF INDUSTRY, CA, 91789, US

(73) Assignee: HON HAI PRECISION INDUSTRY CO., LTD., Tu-Cheng (TW)

(21) Appl. No.: 12/193,778

(22) Filed: Aug. 19, 2008

(30) Foreign Application Priority Data
Mar. 26, 2008 (CN) 200810300728.0

(51) Int. Cl. G06F 13/38

(52) U.S. Cl. 710/62

(57) ABSTRACT

A network device (10) adapted for detecting a type of an adaptor card (100) plugged into the network device. The adaptor card includes card data. The network device includes a line card (200) and a management card (300). The line card detects whether the adaptor card is plugged into the network device, and queries about the type of the adaptor card when the adaptor card is plugged in. The management card reads the card data from the adaptor card, determines the type of the adaptor card based on the card data, and communicates the type of the adaptor card to the line card in response to the query of the line card. An adaptor card type detection method is also provided.

### BACKGROUND

1. Field of the Invention

The present invention relates to network communications, and particularly to a network device and an adaptor card type detection method thereof.

2. Description of Related Art

Line cards are functional components of gateways, and different types of line cards connect to subscribers via different types of adaptor cards. For example, an asymmetrical digital subscriber line (ADSL) line card needs an ADSL adaptor card, while a voice over Internet protocol (VoIP) line card needs a VoIP adaptor card. Thus, when one adaptor card is plugged into a gateway, the gateway needs to detect whether the adaptor card and line card are of the same type, thereby ensuring normal functionality of the gateway.

Conventional gateways distinguish different types of adaptor cards through the different hardware pins of the adaptor cards. However, with the increasing types of adaptor cards, the above method is very inconvenient and requires more pins and the adaptor cards to be large in size. Therefore, a convenient method for detecting different types of adaptor cards is needed to overcome the aforementioned deficiencies and inadequacies.

### SUMMARY

An exemplary embodiment of the present invention provides a network device adapted for detecting a type of an adaptor card plugged into the network device. The adaptor card includes card data. The network device includes a line card and a management card. The line card detects whether the adaptor card is plugged into the network device, and queries about the type of the adaptor card when the adaptor card is plugged in. The management card reads the card data from the adaptor card, determines the type of the adaptor card based on the card data, and communicates the type of the adaptor card to the line card in response to the query of the line card.

Another exemplary embodiment of the present invention provides an adaptor card type detection method adapted in a network device. The network device includes a line card and a management card. The adaptor card type detection method includes the following steps of: the line card detecting whether an adaptor card is plugged into the network device, the adaptor card including card data; the line card querying the management card about the type of the adaptor card when the adaptor card is plugged in; the management card reading the card data from the adaptor card; the adaptor card responding with the card data to the management card; the management card determining the type of the adaptor card based on the card data; and the management card communicating the type of the adaptor card to the line card in response to the query of the line card.

Other advantages and novel features of the present invention will become more apparent from the following detailed description of exemplary embodiments when taken in conjunction with the accompanying drawings, in which:

### BRIEF DESCRIPTION OF THE DRAWINGS

FIG. 1 is a schematic diagram of function modules of a network device according to an exemplary embodiment of the present invention;

FIG. 2 is a transport diagram of an adaptor card type detection method according to another exemplary embodiment of the present invention; and

FIG. 3 is a flowchart of an adaptor card type detection method according to a further exemplary embodiment of the present invention.

### DETAILED DESCRIPTION OF THE EMBODIMENTS

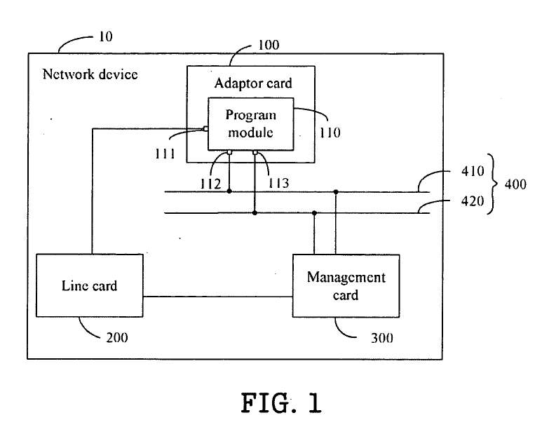

FIG. 1 is a schematic diagram of functional modules of a network device 10 according to an exemplary embodiment of the present invention. In the exemplary embodiment, the network device 10 includes a line card 200 and a management module like a management card 300. When an adaptor card 100 is plugged into the network device 10, the line card 200 can query the management card 300 to determine whether a type of the adaptor card 100 matches with that of the line card 200. If the type of the adaptor card 100 matches with that of the line card 200, the line card 200 supplies power to the adaptor card 100 through which the line card 200 connects to subscribers. If the type of the adaptor card 100 does not match with that of the line card 200, the management card 300 issues a discrepancy notification, so that an operator knows to change the adaptor card 100 to the proper adaptor card. In this embodiment, the network device 10 may be a gateway.

The type of the adaptor card 100 must match with that of the line card 200, otherwise, the adaptor card 100 may be broken due to power. For example, the line card 200 may be, for example, an asymmetrical digital subscriber line (ADSL) line card, and accordingly, the adaptor card 10 must be an ADSL adaptor card. In this case, the network device 10 provides ADSL service for subscribers.

In other embodiments, the line card 200 may be another type of network application line card, and accordingly, the adaptor card 100 must be the same type of network application adaptor card. In this case, the network device 10 provides corresponding service for the subscribers.

The adaptor card 100 is plugged into the network device 10 and includes card data. In this embodiment, the adaptor card 100 includes a program module 110 for storing the card data. The adaptor card 100 further includes a first pin 111, a second pin 112, and a third pin 113. The first pin 111 communicates with the line card 200. The second pin 112 and the third pin 113 communicate with the management card 300 via a serial bus 400. When the adaptor card 100 is plugged into the network device 10, the network device 10 can conveniently detect the type of the adaptor card 100 based on the card data, thereby ensuring that the type of the adaptor card 100 matches with that of the line card 200.

In the detailed embodiment, the program module 110 may be a complex programmable logic device (CPLD). The serial bus 400 may be an inter-integrated circuit (I2C) bus, and includes a serial data line 410 and a serial clock line 420.

The line card 200 detects whether the adaptor card 100 is plugged into the network device 10, and queries the management card 300 about the type of the adaptor card 100 when detecting the adaptor card 100 is plugged into the network device 10. In this embodiment, the line card 200 detects whether the adaptor card 100 is plugged into the network device 10 by the first pin 111. For instance, when detecting a triggering signal, which includes a low or high voltage signal from the first pin 111, the line card 200 can confirm that the adaptor card 100 is plugged into the network device 10. The line card 200 is connected to the management card 300 via the Ethernet, and subsequently, queries the management card 300 to determine the type of the adaptor card 100 via the Ethernet.

The management card 300 reads the card data from the adaptor card 100, determines the type of the adaptor card 100 based on the card data, and communicates the type of the adaptor card 100 to the line card 20 in response to the query of the line card 200. In this embodiment, the management card 300 reads the card data from the program module 110 through the serial data line 410 and the serial clock line 420, respectively communicating with the second pin 112 and the third pin 113. Then, the management card 300 communicates the type of the adaptor card 100 to the line card 200 via the Ethernet.

When receiving the type of the adaptor card 100 from the management card 300, the line card 200 determines whether the type of the adaptor card 100 matches with that of the line card 200, and supplies power to the adaptor card 100 when the adaptor card 100 matches with that of the line card 200. In this embodiment, when the type of the adaptor card 100 is the same as that of the line card 200, the line card 200 determines that the type of the adaptor card 100 matches with that of the line card 200. When the type of the adaptor card 100 is not the same as that of the line card 200, the line card 200 determines that the type of the adaptor card 100 does not match with that of the line card 200, and informs the management card 300 of the discrepancy.

After receiving notice of the discrepancy, the management card 300 issues a discrepancy notification.

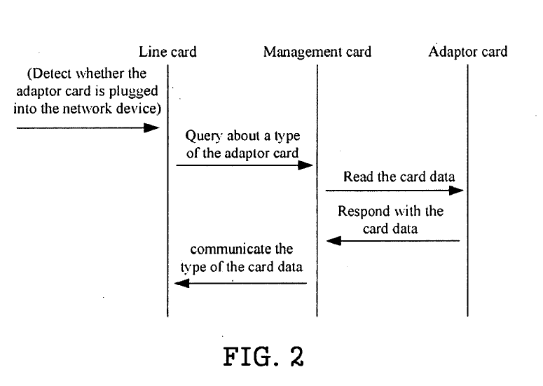

FIG. 2 is a transport diagram of an adaptor card type detection method according to an exemplary embodiment of the present invention.

Initially, the line card 200 detects whether the adaptor card 100 is plugged into the network device 10, and queries the management card 300 about a type of the adaptor card 100. Afterwards, the management card 300 reads the card data from the adaptor card 100, and the adaptor card 100 responds with the card data to the management card 300. Finally, the management card 300 determines the type of the adaptor card 100 based on the card data, and communicates the type of the adaptor card 100 to the line card 200 in response to the query of the line card 200.

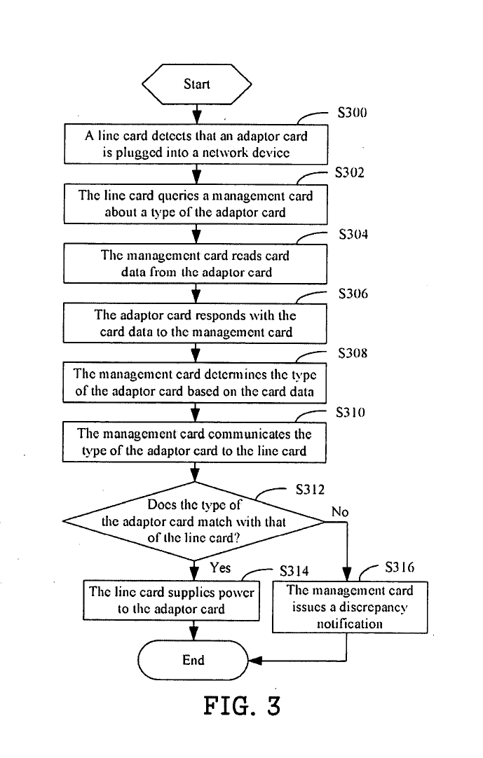

FIG. 3 is a flowchart of an adaptor card type detection method according to another exemplary embodiment of the present invention.

In step S300, the line card 200 detects that the adaptor card 100 is plugged into the network device 10. In this embodiment, the line card 200 detects that the adaptor card 100 is plugged into the network device 10 by the first pin 111. For instance, when detecting a triggering signal, which includes a low or high voltage signal the first pin 111, the line card 200 can conform that the adaptor card 100 is plugged into the network device 10.

In step S302, the line card 200 queries the management card 300 about the type of the adaptor card 100. In this embodiment, the line card 200 is connected to the management card 300 via the Ethernet, and subsequently, queries the management card 300 to determine the type of the adaptor card 100 via the Ethernet.

In step S304, the management card 300 reads the card data from the adaptor card 100. In this embodiment, the management card 300 reads the card data from the program module 110 through the serial data line 410 and the serial clock line 420, respectively communicating with the second pin 112 and the third pin 113.

In step S306, the adaptor card 100 responds with the card data to the management card 300.

In step S308, the management card 300 determines the type of the adaptor card 100 based on the card data.

In step S310, the management card 300 communicates the type of the adaptor card 100 to the line card 200 in response to the query of the line card 200. In this embodiment, the management card 300 communicates the type of the adaptor card 100 to the line card 200 via the Ethernet.

In step S312, the line card 200 determines whether the type of the adaptor card 100 matches with that of the line card 200. In this embodiment, when the type of the adaptor card 100 is the same as that of the line card 200, the line card 200 determines that the type of the adaptor card 100 matches with that of the line card 200. When the type of the adaptor card 100 is not the same as that of the line card 200, the line card 200 determines that the type of the adaptor card 100 does not match with that of the line card 200, and informs the management card 300 of the discrepancy.

If the type of the adaptor card 100 matches with that of the line card 200, in step S314, the line card 200 supplies power to the adaptor card 100.

If the type of the adaptor card 100 does not match with that of the line card 200, in step S316, the management card 300 issues a discrepancy notification to command operators to replace the unmatched adaptor card 100 with the proper type of adaptor card.

Thus, the network device 10 conveniently detects the type of the adaptor card 100 based on the card data of the adaptor card 100, thereby overcoming the deficiencies and inadequacies of the method for distinguishing different types of adaptor cards via hardware pins. Additionally, the adaptor card 100 is connected to the line card 200 by the first pin 111, and is connected to the management card 300 via the serial bus 400 by the second pin 112 and the third pin 113. Therefore, the adaptor card 100 only needs three pins, which allows its size to remain small.

While various embodiments and methods of the present invention have been described above, it should be understood that they have been presented by way of example only and not by way of limitation. Thus the breadth and scope of the present invention should not be limited by the above-described exemplary embodiments, but should be defined only in accordance with the following claims and their equivalents.

What is claimed is:

1. A network device adapted for detecting a type of an adaptor card plugged into the network device, the adaptor card comprising card data therein, the network device comprising:
a line card, for detecting whether the adaptor card is plugged into the network device, and querying about the type of the adaptor card when detecting the adaptor card is plugged in; and
a management card, for reading the card data from the adaptor card, determining the type of the adaptor card based on the card data, and communicating the type of the adaptor card to the line card in response to the query of the line card.

2. The network device as claimed in claim 1, wherein the adaptor card comprises a program module for storing the card data.

3. The network device as claimed in claim 2, wherein the adaptor card further comprises a first pin, a second pin, and a third pin, the first pin communicates with the line card, and the second pin and the third pin communicate with the management card via a serial bus.

4. The network device as claimed in claim 3, wherein the first pin is employed by the line card to detect whether the adaptor card is plugged into the network device.

5. The network device as claimed in claim 3, wherein the serial bus comprises a serial data line and a serial clock line.

6. The network device as claimed in claim 5, wherein the management card reads the card data from the adaptor card through the serial data line and the serial clock line respectively communicating with the second pin and the third pin.

7. The network device as claimed in claim 1, wherein the line card is further used for determining whether the type of the adaptor card matches with that of the line card, and supplies power to the adaptor card when the type of the adaptor card matches with that of the line card.

8. The network device as claimed in claim 7, wherein the management card is further used to issue a discrepancy notification when the type of the adaptor card does not match with that of the line card.

9. An adaptor card type detection method adapted in a network device, the network device comprising a line card and a management card, the method comprising the steps of:
the line card detecting whether an adaptor card is plugged into the network device, the adaptor card comprising card data;
the line card querying the management card about a type of the adaptor card when detecting the adaptor card is plugged in;
the management card reading the card data from the adaptor card;
the adaptor card responding with the card data to the management card;
the management card determining the type of the adaptor card based on the card data; and
the management card communicating the type of the adaptor card to the line card in response to the query of the line card.

10. The adaptor card type detection method as claimed in claim 9, wherein the adaptor card further comprises a first pin, a second pin, and a third pin, the first pin communicates with the line card, and the second pin and the third pin communicate with the management card via a serial bus.

11. The adaptor card type detection method as claimed in claim 10, wherein the step of a line card detecting whether an adaptor card is plugged into the network device comprises the step of:
the line card detecting whether the adaptor card is plugged into the network device by the first pin.

12. The adaptor card type detection method as claimed in claim 10, wherein the serial bus comprises a serial data line and a serial clock line.

13. The adaptor card type detection method as claimed in claim 12, wherein the step of the management card reading the card data from the adaptor card comprises the step of:
the management card reading the card data from the adaptor card through the serial data line and the serial clock line respectively communicating with the second pin and the third pin.

14. The adaptor card type detection method as claimed in claim 9, further comprising the steps of:
the line card determining whether the type of the adaptor card matches with that of the line card; and
the line card supplying power to the adaptor card if the type of the adaptor card matches with that of the line card.

15. The adaptor card type detection method as claimed in claim 14, further comprising the step of:
the management card issuing a discrepancy notification if the type of the adaptor card does not match with that of the line card.

16. A method to detect types of adaptor cards in a network device, comprising:
detecting a plugged status of an adaptor card into said network device;
signally communicating a management module of said network device with said plugged adaptor card through a serial bus which enables said management module of said network device to signally communicate with more than one adaptor card plugged into said network device simultaneously;
retrieving card data from said adaptor card by said management module when said adaptor card is detected to be successfully plugged into said network device; and
determining a type of said adaptor card based on said retrieved card data.

17. The method as claimed in claim 16, wherein said serial bus is an inter-integrated circuit (I2C) bus.
